(19) United States
(12) Patent Application Publication
(10) Pub. No.: US 2013/0240105 A1
(43) Pub. Date: Sep. 19, 2013

(54) ELASTOMER PRODUCT CONTAINING A LINEAR TEXTILE STRUCTURE FOR REINFORCEMENT

(71) Applicant: CONTINENTAL REIFEN DEUTSCHLAND GMBH, Hannover (DE)

(72) Inventors: Peter Zmolek, Hannover (DE); Ulrich Speckhals, Hannover (DE); Joern Krueger, Seelze (DE); Carole Justine, Scharrel (DE)

(73) Assignee: Continental Reifen Deutschland GmbH, Hannover (DE)

(21) Appl. No.: 13/732,879

(22) Filed: Jan. 2, 2013

Related U.S. Application Data
(63) Continuation of application No. PCT/EP2011/058611, filed on May 26, 2011.

(30) Foreign Application Priority Data
Jul. 7, 2010 (DE) 10 2010 017 786.5

(51) Int. Cl. D02G 3/48; B60C 9/18

(52) U.S. Cl. CPC D02G 3/48; B60C 9/1807
USPC 152/526; 57/243; 57/237; 57/255

(57) ABSTRACT

An elastomer product containing a linear textile structure for reinforcement. In order to preserve the environment and resources with a constant product quality, the linear textile structure contains fibers made of polyamide 10.10.

### CROSS REFERENCE TO RELATED APPLICATIONS

This application is a continuation application of international patent application PCT/EP2011/058611, filed May 26, 2011, designating the United States and claiming priority from German application 10 2010 017 786.5, filed Jul. 7, 2010, and the entire content of both applications is incorporated herein by reference.

### FIELD OF THE INVENTION

The invention relates to an elastomer product containing a linear textile structure for reinforcement.

### BACKGROUND OF THE INVENTION

A multiplicity of elastomeric products, such as hoses, conveyor belts, drive belts and pneumatic vehicle tires, contain linear textile structures as strength members for reinforcement. The linear textile structures may be yarns, threads or cords, which are present in the elastomer products as wovens, nonwoven scrims or knits for example. They are known to a person skilled in the art in various forms in terms of construction and material.

Pneumatic vehicle tires generally utilize linear textile structures as yarns or cords in the bead region, as carcass material for belt plies and as a belt bandage. The yarns or cords are embedded in a rubber mixture during tire production in order that they may be utilized in the tire in the form of rubberized strength-member ply.

The purpose of a belt bandage in pneumatic vehicle tires, especially in pneumatic vehicle tires for high-speed service, is to prevent the tire from undergoing a rise due to the centrifugal forces which arise in operation. The position of the belt bandage in a pneumatic vehicle tire (which generally comprises an air-impermeable inner layer; a radial carcass which contains strength members and reaches from the zenith region of the tire through the sidewalls into the bead region and is usually anchored there by wrapping around bead cores which have tensile strength; a radially external rubber tread with profiling grooves; and a belt between the rubber tread and the carcass) is between the belt and the tread. The belt bandage may have a single- or multi-ply construction, covers the belt edges at least and contains strength members that extend in a parallel manner and essentially in the circumferential direction and are in the form of cords embedded in a rubber mixture. In the course of tire production, the belt bandage is applied in the form of plies comprising strength members embedded in an unvulcanized mixture of rubber, which are wound or spooled onto the belt. The strength members for such plies are embedded in rubber by a set of essentially parallel strand-shaped strength members, which have generally been pretreated thermally and/or with impregnation for better adherence to the embedding rubber in a manner known to one skilled in the art, passing in the longitudinal direction through a calender or an extruder for sheathing with the rubber mixture. In the course of shaping with existing tire construction apparatus and the vulcanization of the tire, the tire generally expands in the shoulder region, due to the rise, by up to 2% and in the center region by up to 4% compared with the unvulcanized green tire when the green tire is wound on a flat drum. The strength member used in the belt bandage should therefore advantageously allow this rise, but likewise have suitable shrinking characteristics during tire vulcanization in order that the belt edges at least may be forced down.

Hitherto the materials used for strength members in elastomeric articles of manufacture, especially in belt bandages of pneumatic vehicle tires, have been textile-type strength members based primarily (directly) on fossil-type raw materials (on petroleum), for example PET (polyethylene terephthalate), aramid and nylon or hybrid cords formed from yarns thereof. It is also known to use textile-type strength members which are not petroleum based in that they are based on rayon or lyocell. They are fibers manufactured from natural polymers, viz., cellulose.

It is desirable to minimize the burden on the environment and resources by reducing the proportion in elastomer products which is attributable to petroleum-based raw materials, such as synthetic fibers. But at the same time the properties required of the product must not be impaired.

However, the use in the rubber industry of natural fibers such as cotton is constrained because they do not have the constitution of a continuous filament and because their quality as fiber varies appreciably. Natural fibers also do not shrink and so are unsuitable for use as strength members in belt bandages of pneumatic vehicle tires.

True, rayon as a fiber based on cellulose, that is, not on petroleum, appears to be a possible alternative. However, rayon is disadvantageous because its manufacturing process is environmentally problematical and because its lack of shrinkage is likewise an adverse factor for the specific use as belt bandage.

Rayon is further disadvantageous because it is sensitive to moisture and the breaking strength of the strength member decreases on imbibition of moisture. Moreover, rayon is cost-intensive to procure.

### SUMMARY OF THE INVENTION

The disclosure has for its object to provide an elastomer product containing linear textile structures for reinforcement which without sacrificing product quality is further improved with regard to minimizing the burden on the environment and resources.

We have found that this object of the present invention is achieved when the linear textile structure contains fibers of polyamide 10.10 (PA 10.10).

### DESCRIPTION OF THE PREFERRED EMBODIMENTS OF THE INVENTION

Polyamide 10.10 is a polycondensation product formed from 1,10 -decamethylenediamine and 1,10-decanedioic acid (sebacic acid), both the monomers being obtained from castor oil. Hence polyamide 10.10 is 100% based on natural resources and not on petroleum and hence minimizes the burden on the environment and resources. Castor oil is obtained from the seed of the castor oil plant, which is not used as food plant or as feed plant. What highlights the environmentally friendly character even more is the fact that the castor oil plant thrives under conditions where it is not competing with other crop plants. Moreover, polyamide 10.10 fibers have a consistent quality compared with natural fibers and are obtainable as continuous-filament fibers. Consistent quality can accordingly be ensured for the product as well as processing consistency.

Polyamide 10.10 has high mechanical strength and resistance to chemicals. It also has low water imbibition and so its good properties, such as breaking strength, are retained in the presence of moisture.

Another advantage is that polyamide 10.10 is very similar to polyamide 6.6, frequently used in elastomer products. This makes it easy to exchange polyamide 6.6 for polyamide 10.10 while retaining for example the bonding system used.

In one embodiment of the invention, the linear textile structure is a twisted multifilament yarn and the properties desired in the elastomer product can be achieved via the manufacturing parameters.

In one preferred development of the invention, the multifilament yarn has a fineness in the range from 100 to 5000 dtex and a twist in the range from 100 to 600 t/m. Multifilament yarns of this type are easy to produce and can be used as strength members in pneumatic vehicle tires for example.

In an alternative embodiment of the invention, the linear textile structure is a cord of two or more mutually end-twisted multifilament yarns wherein the individual multifilament yarns each have a fineness in the range from 250 to 4000 dtex and a first twist in the range from 100 to 600 t/m and were end-twisted together at a twisting rate in the range from 100 to 600 t/m. Polyamide 10.10 is thereby used similarly to polyamide 6.6 or polyester. It is preferably 2 or 3 multifilament yarns which are end-twisted together in the cord.

The multifilament yarns in the cord can all consist of polyamide 10.10. This has the advantage that the entire cord consists of a material that minimizes the burden on the environment and resources.

But it is also possible for at least one multifilament yarn of the cord not to consist of polyamide 10.10. A so-called hybrid cord is then concerned. This hybrid cord is then at least partly engineered to be environmentally friendly and to minimize the burden on resources and has the further advantage of making it possible to vary the cord in a defined manner via the specific choice of material for the yarn not consisting of polyamide 10.10.

The at least one yarn not consisting of polyamide 10.10 may preferably be a multifilament yarn of polyester (for example, PET or PEN), a polyamide type other than polyamide 10.10, aramid or polyketone (for example, Arselon®).

However, it is particularly preferable to use fibers manufactured from natural polymers, such as rayon or lyocell, or natural fibers. The entire hybrid cord is then made of materials that are not based on petroleum, and is adjustable in its properties in a defined manner through suitable selection of material for the yarns.

The elastomer product according to the invention is preferably a pneumatic vehicle tire. Pneumatic vehicle tires are high-volume products where the exchange of petroleum-based materials for materials that are not based on petroleum leads to a particularly large effect in respect of minimizing the burden on resources. Also, textile structures in the tire which contain fibers of polyamide 10.10 are found to lead to high durability.

The linear textile structure containing fibers of polyamide 10.10 is preferably used in the belt bandage of pneumatic vehicle tires because it is there that the shrinkage behavior and the thermal stability of polyamide 10.10 have a positive effect in particular.

A passenger car tire may for example comprise a belt bandage formed from hybrid cords of the following construction wherein at least one of the multifilament yarns consists of polyamide 10.10:
Version A:
   rayon; fineness 1100 dtex×1, first twist 380 t/m polyamide 10.10: fineness 700 dtex×1, first twist 380 t/m end twist of the two multifilament yarns: 380 t/m
Version B:
   lyocell: fineness 1670 dtex×1, first twist 250 t/m polyamide 10.10: fineness 1400 dtex×1, first twist 380 t/m end twist of the two multifilament yarns: 380 t/m
Version C;
   rayon; fineness 1100 dtex×1, first twist 380 t/m polyamide 10.10: fineness 700 dtex×1, first twist 380 t/m polyamide 10.10: fineness 700 dtex×1, first twist 380 t/m end twist of the three multifilament yarns: 380 t/m

Tires comprising a bandage formed from the aforementioned hybrid cords are an improvement with regard to minimizing the burden on the environment and resources.

It is understood that the foregoing description is that of the preferred embodiments of the invention and that various changes and modifications may be made thereto without departing from the spirit and scope of the invention as defined in the appended claims.

What is claimed is:

1. An elastomer product having a linear textile structure for reinforcement, wherein the linear textile structure comprises fibers of polyamide 10.10.

2. The elastomer product as claimed in claim 1, wherein the linear textile structure is a twisted multifilament yarn.

3. The elastomer product as claimed in claim 2, wherein the multifilament yarn has a fineness in the range from 100 to 5000 dtex and a twist in the range from 100 to 600 t/m.

4. The elastomer product as claimed in claim 1, wherein the linear textile structure is a cord of two or more mutually end-twisted multifilament yarns wherein the individual multi-filament yarns each have a fineness in the range from 250 to 4000 dtex and a first twist in the range from 100 to 600 t/m and were end-twisted together at a twisting rate in the range from 100 to 600 t/m.

5. The elastomer product as claimed in claim 4, wherein the cord consists of 2 or 3 end-twisted multifilament yarns.

6. The elastomer product as claimed in claim 4, wherein the multifilament yarns of the cord all consist of polyamide 10.10.

7. The elastomer product as claimed in claim 4, wherein at least one multifilament yarn of the cord does not consist of polyamide 10.10.

8. The elastomer product as claimed in claim 7, wherein the at least one multifilament yarn consists of polyester, a polyamide type other than polyamide 10.10, aramid, polyketone.

9. A pneumatic vehicle tire comprising the elastomer product as claimed in claim 1.

10. The pneumatic vehicle tire as claimed in claim 9, wherein the linear textile structure is disposed in the belt bandage.

11. The elastomer product as claimed in claim 8, wherein the at least one multifilament yarn consists of fibers manufactured from natural polymers or of natural fibers.
